(19) United States
(12) Patent Application Publication
(10) Pub. No.: US 2003/0010141 A1
(43) Pub. Date: Jan. 16, 2003

(54) Continuously active motor

(76) Inventor: Paulo Crisogno Sidney, Piracicaba (BR)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/169,620

(22) PCT Filed: Jan. 24, 2001
(86) PCT No.: PCT/BR01/00007

(30) Foreign Application Priority Data
Jan. 27, 2000 (BR) PI 0002041-9

(51) Int. Cl. F03G 7/10

(52) U.S. Cl. 74/84 S

(57) ABSTRACT

A method of construction of a moving machine acting non-stop is presented, consisting of how to use the Reaction Force Energy to produce motive kinetic activity without offering any conservative or potientially contrary condition to its original restitution. The simultaneous use of these forces to actuate simple machines, which are integrated in an articulate way and under the influence of potential or kinetic mechanical physical agents, will allow to generate mechanical energy in an economic, abundant, environmentally-friendly and universely adaptable way.

(Remark: it is distinct from all other motors because, added to the natural entropical function, as the only viable skilled ones, the use of a form of energy not offering any conservative or potentially contrary condition to the kinetic motor activity being produced is implemented for its original integral restitution.)

The present invention consists of how to make use of the “Reactive Energy”, simultaneously to the action of simple machines which are integrated in an articulated form, under the influence of physical, potential or kinetic, agents, to assemble a machine which moves in a non-stop action and which, without any complex or inadequate mechanisms, will be useful as a nano-machine and even with large structures, and will be functional on the ground or space, when multifunctional in subsidiary applications.

Its dynamic efficiency is mathematically and mechanically proved, and the analysis envolves the Mechanical Engineering field. As a bigger difficulty, it is noteworthy that, by means of interchangeable devices, the idea was to assemble it as the presumed invention by explaining its operation step by step, but a domestic assembly has not followed the dimensional precision as required for its fully working conclusion. However, it offers an easy and inexorable explanation of such understanding in which, as shown in a first stage, it is shown that the implement energy does exist and, when applied in a second stage, its capacity of working continuously can be shown in details and very clearly.

The assembling method will be illustrated as attached with ten pages and thirty figures, which will be summarized as follows:

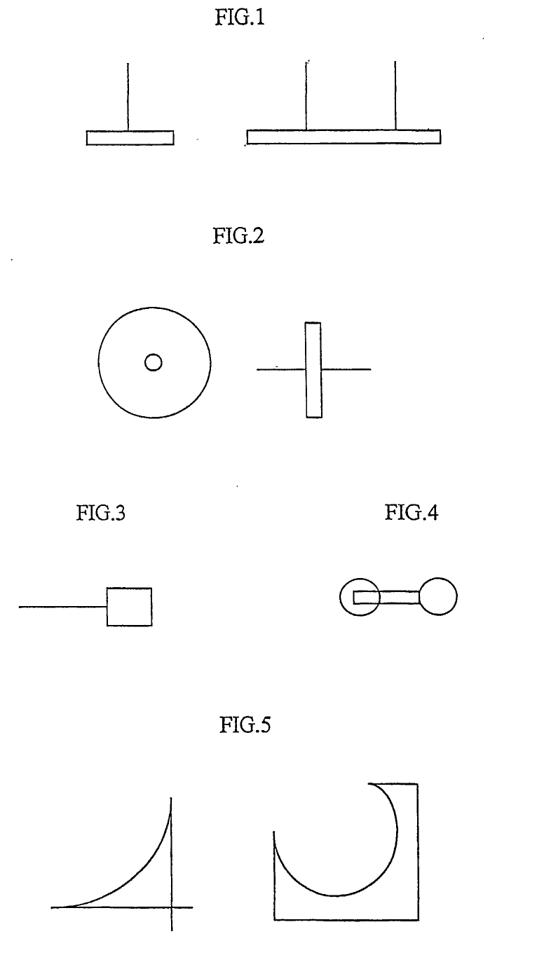

FIG. 1=A.1—fixed basis (elevation side view);

FIG. 2=B.1—moving basis (elevation side view);

FIG. 3=B.1—activating system;

FIG. 4=B.3—propeller system;

FIG. 5=B.6—guiding machine system;

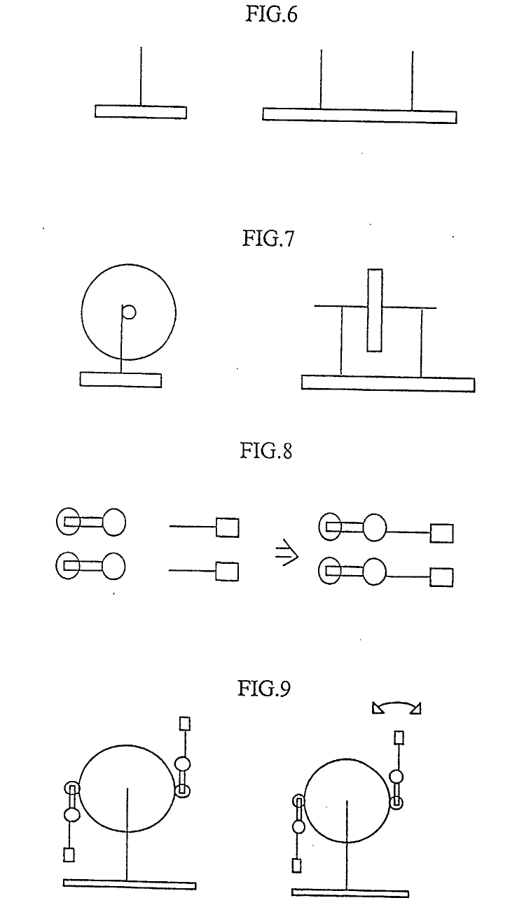

FIG. 6=(start of final assembly) positioning the fixed basis;

FIG. 7=assembling the motor assembly: first step: joining basis (elevation side view);

FIG. 8=second step: manufacturing propeller-activating systems (S.A-P);

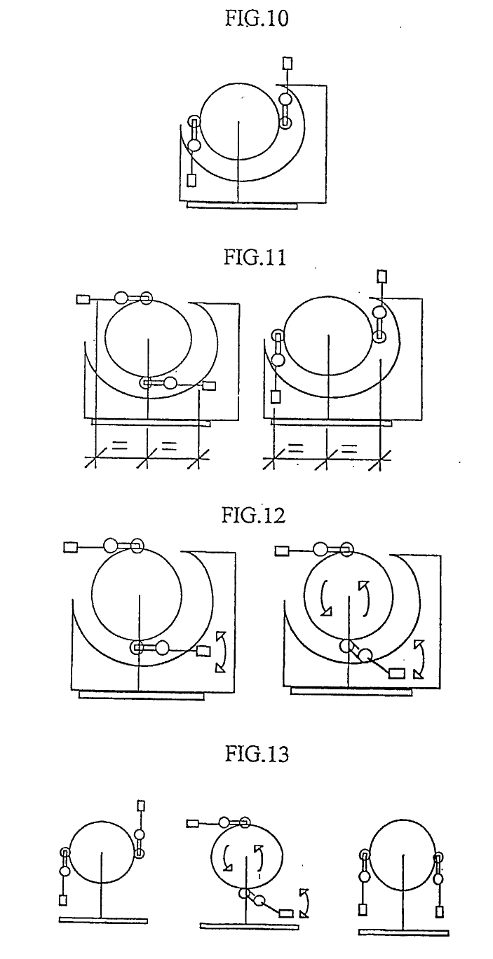

FIG. 9=third step: assembling to the moving basis (sequence of two drawings);

FIG. 10=fourth step: assembling the guiding machine system; when this step is completed, the machine becomes functional and the physical-dynamic explanation starts;

FIG. 11=S.A-P at equal distances present null resulting forces;

FIG. 12=such relation differs when they can move (please read small changes in the drawing of the sloping S.A-P as equal to the straight ones);

FIG. 13=without limiters, it would naturally work at 180° until balanced;

FIG. 14=with reactive energy, second action arm and (I=ΔQ);

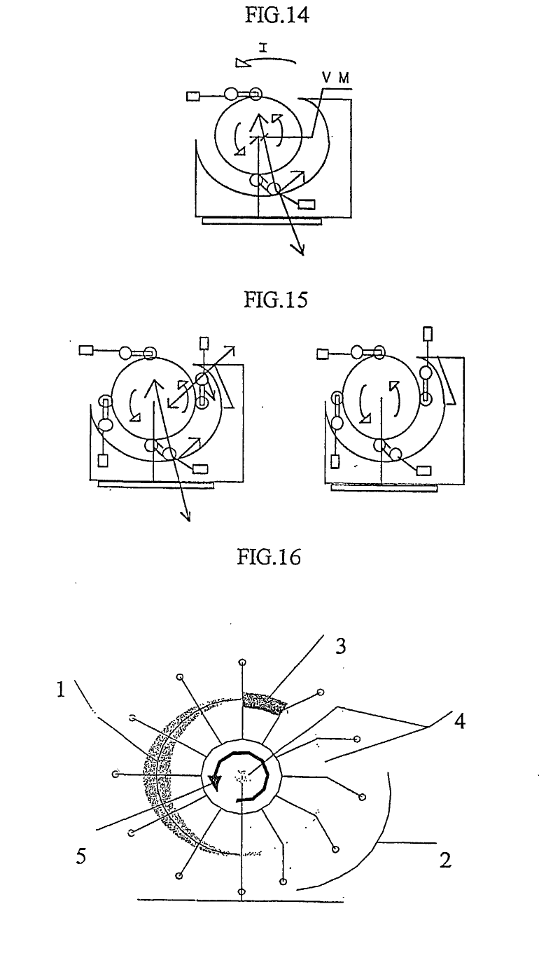

FIG. 15=a “functional mechanism under continuous cycle” is concluded;

FIG. 16=an energetically illustrated motive cycle (sequences 1 to 5);

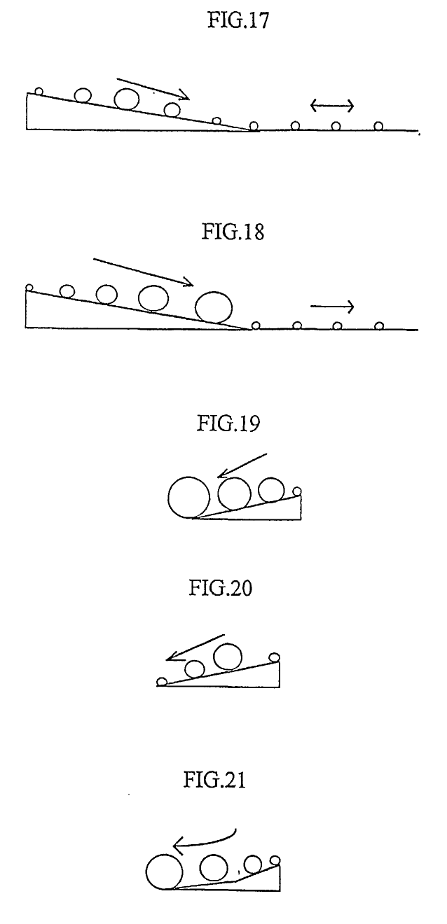

FIG. 17=first arrangement of motive forces;

FIG. 18=second motive arrangement;

FIG. 19=first arrangement of restitution forces;

FIG. 20=second restitution arrangement;

FIG. 21=third restitution arrangement;

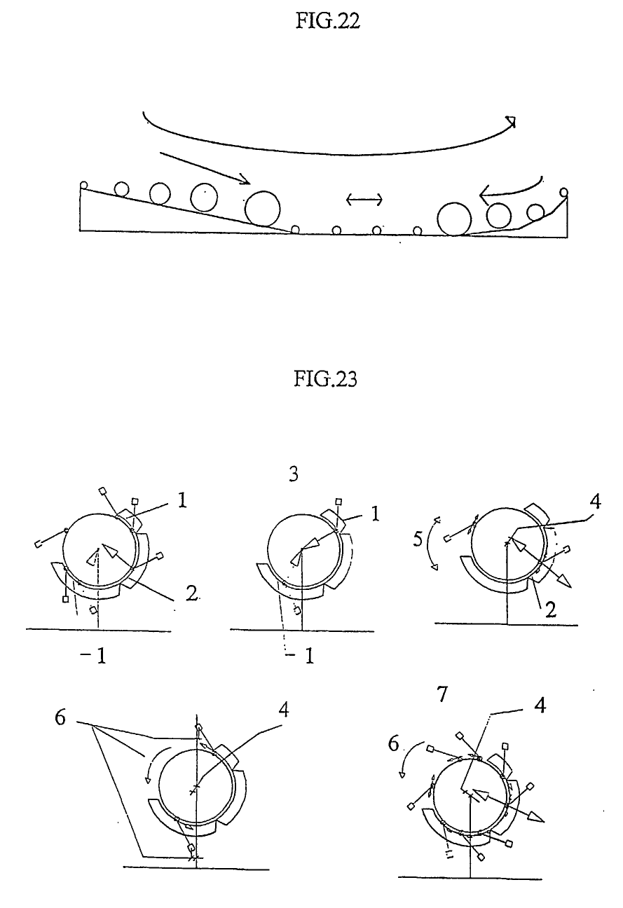

FIG. 22=a complete functional sequence;

FIG. 23=a detailed example (first case) (sequences 1 to 7);

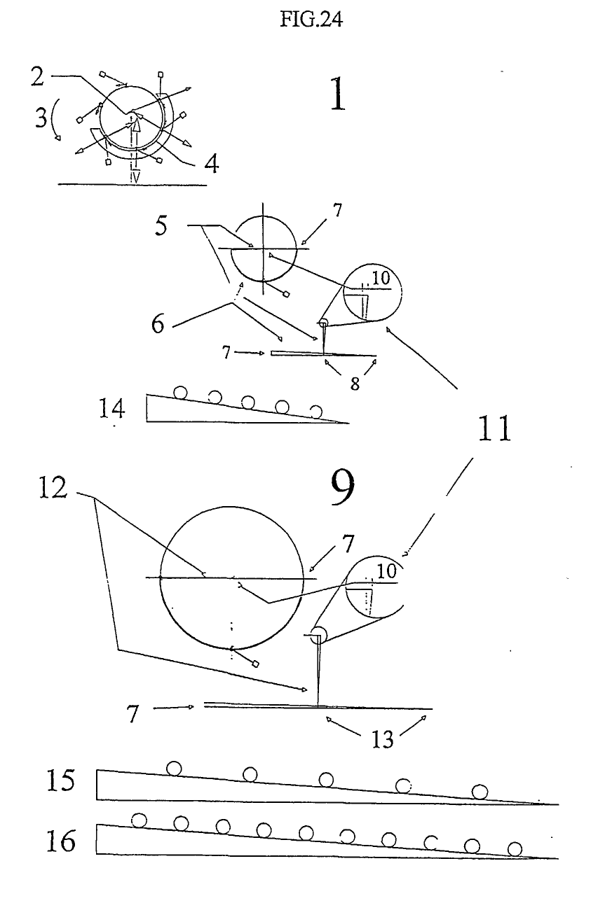

FIG. 24=(second case) (sequences 1 to 13);

FIG. 25=constant motive energy flux;

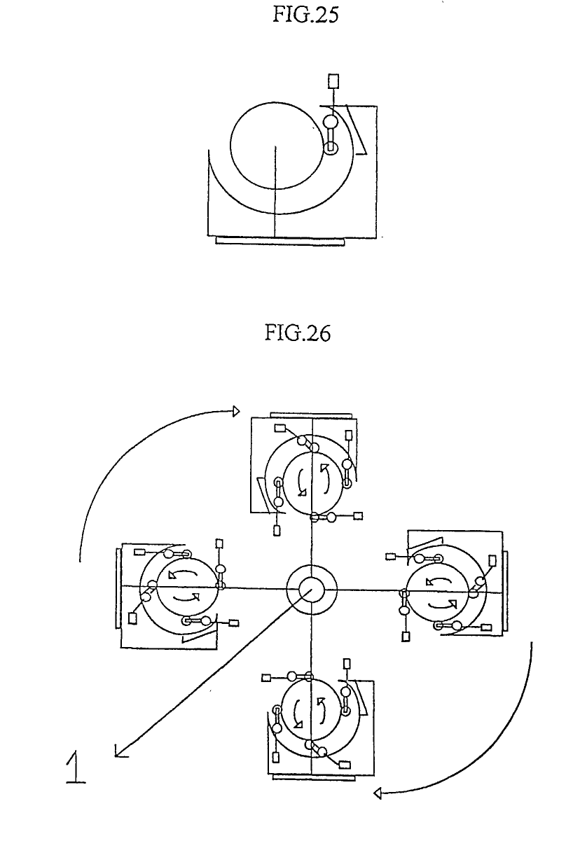

FIG. 26=use of kinetic energy;

FIG. 27=assembling subsidiary assemblies: incremental devices (Ex. 1);

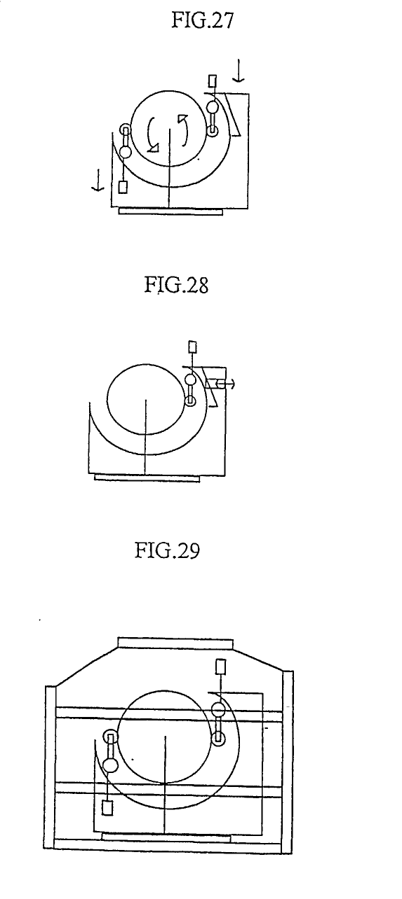

FIG. 28=Example 2;

FIG. 29=protection and transport devices;

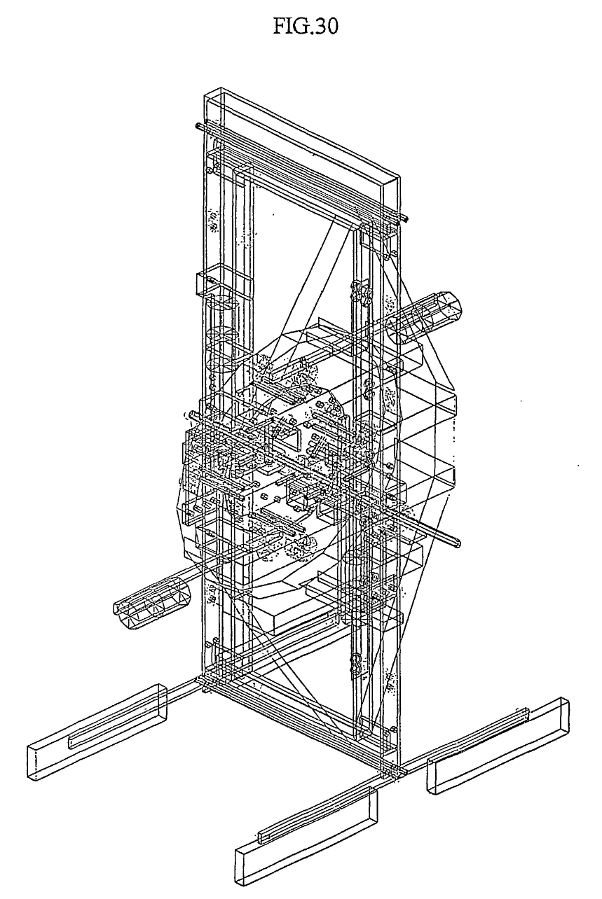

FIG. 30=functional demonstration prototype.

### CONSTRUCTION METHOD: BASIC STRUCTURE

A) Basic Assembly: Support Structures

A.1—Fixed Basis: Support structures to the Motive Assembly or to the assembly supplying appropriate support (1).

B) Motive Assembly: Assembly Generating Motive Power

B.1—Moving Basis: Device for possible moving in a closed course, as a wheel being centrally trans-fixed by a shaft through which protraction the useful energy can be taken (2).

B.2—Activating System: The Activating System is any body which can be put into action, such as a shaft with a material grouping preeminently moving the mass center to one of its ends and which, working under the action of mechanical (potential or kinetic) forces, has the purpose to activate the propeller system, by making it become more solid (3).

B.3—Propeller System: These systems have the purpose to make the job of propelling the moving basis when activated by the relationship of the Activating System when in contact with the orientation of guides assembled as machines. Example: a plate where fixation rollers will be coupled over one of its ends and force guiding rollers over the other end (4).

B.4—Limiting Systems: Groups of restraints or protections with the purpose to limit the activation/propeller action to which the first two assemblies are coupled and these are coupled to the Moving Basis.

B.5—Movement Control Device: System of brakes or restraints with the purpose to control the movement of the Motive Assembly.

B.6—Guiding Machine System: Systems for support and orientation of the course of work of the Activating/Propeller System. Example: a steel plate with a spirally extended sloping plan segment, which supplies the required support to the activation/propelling movement before the circular route of the Moving Basis and functionally completes the machine as an object (5).

C—Subsidiary Mechanical Assembly: Devices to Help in the Use of Energy

C.1—Subsidiary Incremental Devices: Devices can also be added to increment, under natural or artificial action, the accomplishment of essential activities. Example: free falling action of the bodies incorporated into the activating assembly, or the action of springs at the restitution segment of the guiding machine system or even electrical motors using a part of the generated energy to help in the restitution job.

C.2—Self-Lubrication and Self-Refrigeration Devices: A device which is activated by friction generates heat, an energy which can dismantle it; the quality or the working life of that device depends on many factors. Therefore, appropriate materials used in its construction or null dissipation conditions generally extends the working life of the motor.

C.3—Protection And Transport Device: Devices moving freely should be appropriately protected, as well as eventual means for the transport of such portable parts. Once basically structured, manipulated and prepared in a conclusive assembly, such devices should be integrated as a functional mechanical system, which purpose will be to form a motor which is able to autonomously generate kinetic changes from the state of inertia of assembled bodies, such as machines operated by the action of physical agents (potential or kinetic), to occur when an extraordinary inventive implement is provided with the single/entropical action by means of a mechanical arrangement which, when positioned as a single energy flux with motive mechanical capacity of higher power than the eventual opposition forces, makes use of said opposition forces, which control is naturally constant or variable and formed by the rationalized job of restitution, as imposed by the condition of mechanical energy conservation added to the full dissipating condition. Such dissipation may be from null, under vacuum and very high conductivity, to an appropriate potential value which may contain or release movement indefinitely.

So methodically guided as an object, the step of assembling the primarily composed structures may follow the following order or stages:

First stage: positioning of the Fixed Basis Assembly as a basic structure or support to fix the Motor Assembly (6).

Second stage: assembling of the Motor Assembly, comprising various subsets or systems, which will be explained step by step:

First step: to join the Moving Basis to the Fixed Basis (7).

Second step: to manufacture pairs of units of Activating/Propeller Systems (8).

Third step: to integrate such assembled systems, at equal distances and at 180° , to the Moving Basis, by applying the Limiters and the Movement Control System, where such fixed Activating/Propeller Systems may work as a lever around its own axis before the central axis (9).

Fourth step: to assemble the Guiding Machine System (10). When this step is completed, the machine becomes functional. and mechanical energy is dinamically rationalized as a. useful and continuous motive capacity to be applied as. such.

In any position, the mass center of the Activating/Propeller Systems, when fixed to the Moving Basis, will be at an equal distance from each other, presenting consequent null or static forces (11). However, these systems can move around an axis of their own once released within a limit and make this equal distance relationship around such a central axis (12) become different. When this happens, the whole motive assembly, as activated by an entropical action which is proportional to the mechanical advantage, acquires energy to move and develop a rotation job.

The Activating/Propeller System would naturally work at 180° if no movement limiters were present, thus propelling the whole motive assembly until reaching an equilibrium stage or a maximum entropy state again (a condition consisting of the description of free movement from unequal energy distribution to a balanced one) (13). However, following the First Law of Thermodynamics, according to which “energy cannot be created nor destroyed, but transformed”, or due to the conservation conditions of mechanical energy, any working mechanism would later need the full quantity of produced energy to recover its original working energy capacity and, after subtracting the dissipated energy by friction when an additional force implement of the same value is required but considered as non-existent for a common reason which makes impossible the compensation of such integrity, this condition will make the free continuous working of any part of the machine and/or a new functional cycle become unviable.

After studying how to solve the above described situation or to make a creative idea with a self-motive sense, the present invention constitutes a distinct method of machine construction, where an energy flux is mechanically offered with a potential motive capacity of more than the required power to restitute the same capacity in an integral and perpetual fashion. This makes it possible to work continuously at activation/propelling cycles of 180° where this natural problem is dynamically overcome by the rotation before the change in positions of the positioned pairs, by the “Laws of Movement” as formulated by Isaac Newton. These comprise three basic principles, including the First Law which is inertia, or “the resistence of an object against movement changes”. These systems, initially in a rest position or at equal distances from each other, when artificially propelled or in an arrangement guiding the difference of distances from their mass centers, so to entropically and singularly create a mechanical advantage or motive action force, require later, with the help of the “principle of action and reaction”, which is the Third Law of Movement according to which “to an action, a reaction of the same intensity and direction but contrary sense always opposes” (being noteworthy the importance of a fundamental concept according to which an action and a reaction never neutralize themselves, since they always act over different bodies where the energy of action of a machine can supply movement, by means of the reaction energy, to its own inertial/spatial fixation axis, which can exactly be obtained by means of the activation/propelling contact when supported by the Guiding Machine System), the application of the “reactive energy” element as a source of initial force integrating the motive and proportional composition in a mechanical advantage to a second arm of action around the center of the Motive Assembly which, according to the Second Law of Movement as vectorially represented by FIG. 14, originates or produces a resulting form which is transformed (F=m.a) into an impulse calculated as (I=ΔQ) in which, by taking advantage of what was completely unknown before but from now on can be considered in any way as being an extraordinary energy implement always existing available for enjoyment or use and for reason of progressive/relative increase when, in a more than compensatory effect, with the restitution of action of simple potential machines such as a lever, when also effected in a simultaneous event in response to such an energy capacity (this specifically means no conservative energy or potential force contrary to the impulse produced in initial sense) and which, when the dissipating condition of friction is also adjusted, any desired potential as a motive function is obtained by always keeping the same potential of restitution needs, as long as used basically for the kinetic extension of the movement in an eventual break of a possible pendular/dissipating activity of the Activating/Propeller System and consequently by adequating the new position which, at last, is correspondingly prepared and, when multiplied, intensified and adding the units of force in a first segment as a motive activity with a larger power than other contrary segment as a restitution activity with smaller potential, a “functional mechanism working at continuous cycle” is concluded, wherein all eventually remaining motive power will be useful energy (15). Such a motive cycle as energetically illustrated presents the basis over which the mode of application of the force units or positioning in general, both at the activating/propelling function or within the job of restitution, may be presented in various arrangements (16). Motive capacity (16-1). Region of entropical/singular action, where the reactive energy is implemented (16-2). Restitution job (16-3). Total dissipating condition (16-4). Useful energy (16-5).

The energetical mechanical flux with motive capacity can be prepared e. g. to be included in the first functional 90°, when the Activating/Propeller System is put into action, with direct support or orientation by any limiting system and would be later applied, in the following segment, with the Guiding Machine Systems or the dynamic reason for reactive energyc implement; and, by graphically analysing the effect of the forces in action or by putting them in contact with the spiral segment, they would be planarly extended (17). In a second example, the Guiding Machine Systems would be applied for reactive energy implement at all motive segments, so to increase the working power of each moving system (18).

On the other hand, the restitution job can be made by means of appling over this segment just the Limiting Assemblies (19). In a second example, the reactive energy implement would also be applied to the whole restitution segment (20). Or even, in a third arrangement, by applying to the segment a course which is similar to a parabola, where different slopings are added to the description or where the power percentage required for the restitution job decreases at each moment of movement. Even so, the motive energy is generated in a spiral course or at a proportionally larger distance. This very same energy can be restituted at smaller and smaller distances, thus significantly adapting itself to a constant restituting cycle of the original integral energy (21). And here we have a full sequence with an application of dynamically rationalized forces (22).

### DETAILED EXAMPLES OF POSSIBILITIES

As seen, there are various functional arrangements which may be applied, but two cases will eventually be explained as dynamic and detailed examples. These prove in reality to be as intelligent as the use entitled Extraordinary Reactive Energy Implement and we come to the conclusion that it is in fact possible to use and enjoy “the physical and artificial search for a useful continuous motive mechanical cycle” or the inventive original application, thus legitimating the “Continuous Action Motor” as authentic and multi-function.

First Case

The single entropical action and the restitution job are singularly limited or the reactive energy function is solely used for one course period of the Activating/Propeller System responsible for the reduction of the restitution period before this fundamental embodiment (23). Circular segment (23-1). Spiral segment (23-2). Limiting function with the circular segment (23-3). Application of Reactive Force as a second action arm with a mechanical advantage (23-4). Equilibrium (23-5). Singular/entropical action naturally creating an impulse by 90° (23-6). In this case, the motive potential can be larger than the power required by the restitution job to obtain its original energy capacity (23-7), provided that the reactive function is no longer advantageously applied, thus finally compensating within null forces the relationship of positioned pairs with the central axis and from which the restitution job starts to exist adding appropriately this energy implement, or even if the integral job is now submitted to a dissipation system.

Second Case

The reactive action is applied as an impelling function over the whole period of the activating/propelling motion or restitution action (24). The motor assembly submitted to the action of an activating/propelling power receives therefore in mechanical advantage an impulse for a given time period. “Impulse Theorem: the resulting impulse as communicated to a body within a given interval of time is equal to the variation in quantity of movement of the same body for the same time interval.” From the Second Law of Newton, we can conclude the following:

When the impulse is ended, the whole motor assembly will be provided with kinetic energy. “Kinetic Energy Theorem: the job made by the resulting force acting over a body is equal to the variation of kinetic energy suffered by the same body.” Desired dimensions (24-1). Mechanical advantage (242). Impulse (24-3). Spiral segment (24-4). The fixation point of the Activating/Propeller System is positioned at a R=250 mm (24-5). Spiral segment extended as a sloping plan and VM analysis as applied around the central axis (24-6). Distance of spiral opening D=0.5 mm (24-7). Symmetrical angles (24-8). Folding dimensions (24-9).

“Mathematical proof”: although the ratio of spiral opening has to be divided by half to keep the same potential restitution value, the lever arm dimension before the center of the motor assembly will be twice as big and this keeps the mechanical advantage unchanged (24-10), both in the first activating/propelling force ratio as applied to a given radius and after such force divided by half is applied to a dimensionally folded radius (24-11). R=500 mm (24-12). Simmetrical angles equivalent to half the first relationship (24-13). “Principle of conservation of mechanical energy: in a conservative system, mechanical energy will always be the same at any moment.” Therefore, despite the dissipating conditions when summed to the “Principle of conservation of mechanical energy” where the natural actions are transformed into contrary integral energy job or restitution potential, when the reactive energy implementing a solution is used; even this same impulse power (24-14) may be kept for a longer period (24-15) or may be folded into the number of power units within the same space of action (24-16), and this can be done in progressively related ratio before the same restitution potential.

Constant Motive Energy Flux

These examples of possibilities show that the generation of motive power is effected in such a way that the movement will be accelerated in a given moment and slow shortly afterwards. To keep the movement or the motive energy flux as a constant, the mode of restitution arrangement as previously described by Example 3 should be applied, thus describing different slopings, applying a course being similar to a parabola which, due to the travelled space, adjusts the percentual of contrary force by making the required restitution potential become equal at each moment (25).

Use of Kinetic Energy

We have so far examined the use of potential energy as a main source of power, but kinetic energy can also be advantageously used, such as a function of centrifugal energy action (26-1) where, in an “M. A. C.” grouping feeding the turn at increasing speeds by one of the motors in the chain, the power to generate useful energy by the other motors can be increased until breaking the weakest link in the support device or by accelerating their masses until their relative limits (26).

Third Stage: Assembling Subsidiary Assemblies

Incremental Job Devices

Incremental power devices with supports can also be added as subsidiaries. Example: the action of free fall of bodies of the activating assembly (27) or the spring action with the guiding machine function (28).

Null Dissipating Forces

With devices producing refrigeration for very high conductivity actions under vacuum, dissipating forces are nulled or the heat that may dismantle the systems constituting the machine is appropriated to supply conditions for perpetual or eternal movement.

Protection and transport devices (29).

1. CONTINUOUSLY ACTIVE MOTOR, in which the invention of a method of construction of a moving machine acting non-stop, consisting of how to use the Reaction Force Energy to produce motive kinetic activity without offering any conservative or potentially contrary condition to its integral/original restitution, when existing as simultaneously applied to the action of simple machines which are integrated in an articulate way and under the influence of potential or kinetic mechanical physical agents, which will be able to generate mechanical energy in an economic, abundant, environmentally-friendly and universely adaptable way if under the influence of such an implementing process.

2. REQUEST FOR AN EVENTUAL CONCLUSIVE AUTHORIZATION: knowing that the invention of such devices is disreputable and it is not yet fully functional, which makes it difficult to call the attention to judge the possibility, it is noteworthy that this motor is mathematically (24-11) and mechanically (30) well fundamented, or works without disrespecting any natural rules, such as the creation or destruction of energy, making sole use of the full sense of transformation of the available energies but even so, in consideration of a possible lack of interest for the analysis, I hereby request an opportunity to make the conclusive prototype where two models, an explanatory and a fully functional one, will be required since, due to the idea of unifying presentations, there was no dimensional precision, which will now be attempted with the use of more sophisticated machinery and machining and for which, as long as duly presented or with no prejudice to the inventive merit, I, as a Mechanics Technician, can look for manufacturing sponsorship with a conveniently interested corporation, for being aware of all the process ideas, including the project, and with the information I already have in hands.
